(19) United States
(12) Patent Application Publication
(10) Pub. No.: US 2025/0220648 A1
(43) Pub. Date: Jul. 3, 2025

(54) INTELLIGENT ALLOCATION OF RESOURCE BLOCKS BASED ON MAXIMUM POWER REDUCTION

(71) Applicant: AT&T Intellectual Property I, L.P., Atlanta, GA (US)

(72) Inventors: Jianchun Zhou, Bellevue, WA (US); Yakun Gao, Suwanee, GA (US)

(21) Appl. No.: 18/399,676

(22) Filed: Dec. 28, 2023

(51) Int. Cl. H04W 72/0453; H04L 5/14; H04W 52/36; H04W 72/512

(52) U.S. Cl. CPC H04W 72/0453; H04L 5/1469; H04W 52/367; H04W 72/512

(57) ABSTRACT

A method for intelligently allocating resource blocks of a radio frequency spectrum band includes detecting a presence of a plurality of user endpoint devices within a cell of a radio access network, wherein the plurality of user endpoint devices includes a first user endpoint device and a second user endpoint device, identifying a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block, determining that the first user endpoint device is more likely than the second user endpoint device to be negatively impacted by maximum power reduction, and allocating, in response to the determining, the first resource block to the first user endpoint device.

The present disclosure relates generally to wireless communications and relates more particularly to devices, non-transitory computer-readable media, and methods for intelligently allocating resource blocks based on maximum power reduction.

### BACKGROUND

Radio frequency (RF) amplifiers are used in wireless devices (such as mobile phones, tablet computers, Internet of Things (IoT) devices, connected vehicles, and the like) in order to increase the power of the RF signals that are transmitted and received by the wireless devices, which can weaken or become distorted as they travel through the air due to interference from other devices or structures. By amplifying the RF signals, an RF amplifier can help to improve the reception of a wireless device, even in areas where the RF signal strength is normally low. An RF amplifier can also help to improve the quality of the RF signals by reducing noise and distortion.

### SUMMARY

In one example, the present disclosure describes a device, computer-readable medium, and method for intelligently allocating resource blocks of a radio frequency spectrum band based on maximum power reduction. For instance, in one example, a method performed by a processing system including at least one processor includes detecting a presence of a plurality of user endpoint devices within a cell of a radio access network, wherein the plurality of user endpoint devices includes a first user endpoint device and a second user endpoint device, identifying a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block, determining that the first user endpoint device is more likely than the second user endpoint device to be negatively impacted by maximum power reduction, and allocating, in response to the determining, the first resource block to the first user endpoint device.

In another example, a non-transitory computer-readable medium stores instructions which, when executed by a processor, cause the processor to perform operations. The operations include detecting a presence of a plurality of user endpoint devices within a cell of a radio access network, wherein the plurality of user endpoint devices includes a first user endpoint device and a second user endpoint device, identifying a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block, determining that the first user endpoint device is more likely than the second user endpoint device to be negatively impacted by maximum power reduction, and allocating, in response to the determining, the first resource block to the first user endpoint device.

In another example, a device includes a processor and a computer-readable medium storing instructions which, when executed by the processor, cause the processor to perform operations. The operations include detecting a presence of a plurality of user endpoint devices within a cell of a radio access network, wherein the plurality of user endpoint devices includes a first user endpoint device and a second user endpoint device, identifying a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block, determining that the first user endpoint device is more likely than the second user endpoint device to be negatively impacted by maximum power reduction, and allocating, in response to the determining, the first resource block to the first user endpoint device.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for intelligently allocating resource blocks of a radio frequency spectrum band based on maximum power reduction may operate;

FIG. 2 illustrates a graph plotting the power output of a power amplifier against the bandwidth of a radio frequency spectrum band;

FIG. 3 illustrates a flowchart of an example method for intelligently allocating resource blocks of a radio frequency spectrum band based on maximum power reduction, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides devices, non-transitory computer-readable media, and methods for intelligently allocating resource blocks of a radio frequency spectrum band based on maximum power reduction. As discussed above, RF amplifiers are used in wireless devices (such as mobile phones, tablet computers, IoT devices, connected vehicles, and the like) in order to increase the power of the RF signals that are transmitted and received by the wireless devices, which can weaken or become distorted as they travel through the air due to interference from other devices or structures. By amplifying the RF signals, an RF amplifier can help to improve the reception of a wireless device, even in areas where the RF signal strength is normally low. An RF amplifier can also help to improve the quality of the RF signals by reducing noise and distortion.

Although typical RF power amplifiers can transmit at their maximum power level over most of the linear range of an RF spectrum band, some amount of signal predistortion is typical at the ends of the spectrum band due to inherent linearization limitations of the power amplifiers. This signal predistortion was not considered to be a major problem in frequency division duplexing (FDD) Fourth Generation (4G)/long term evolution (LTE) networks, where each spectrum band is typically no more than twenty megahertz (MHz) wide for LTE, or fifty MHz for Fifth Generation (5G) in FDD mode. However in 5G networks that support time division duplexing (TDD), many spectrum bands can have bandwidths of up to 100 MHz per channel for frequency range 1 (FR1), or 400 MHz per channel for frequency range 2 (FR2). Signal predistortion at either end of a spectrum band this large can cause significant degradation in customer quality of experience.

The Third Generation Partnership Project (3GPP) attempts to mitigate signal predistortion through maximum power reduction (MPR). MPR defines an allowed reduction of the maximum transmit power of a wireless device. The magnitude of the MPR varies depending upon the position of an allocated resource block (RB) in an RF spectrum band and the modulation scheme (e.g., amplitude modulation, frequency modulation, phase modulation, or the like) that is used. For instance, MPR may be zero or near-zero for RBs that are closer to the middle of an RF spectrum band, but much higher for RBs that are closer to the ends of the RF spectrum band. Thus, wireless devices that are allocated RBs closer to the ends of the RF spectrum band may experience a higher degree of coverage loss due to poor reference signal received power (RSRP) and signal-to-interference-and-noise ratio (SINR) as a direct result of the reduced transmit power.

Present day wireless networks allocate RBs randomly to mobile devices, without considering whether a mobile device is in the near cell (e.g., physically located near the middle of the coverage area of a base station) or at the cell edge (e.g., physically located at the edge of the coverage area). Differences in application priority and physical radio channel types are also typically not considered when allocating RBs to mobile devices. Thus, RBs of the RF spectrum bands tend not to be allocated in the most optimal manner.

For instance, when multiple wireless devices are sharing an RF spectrum band, it may be possible that a wireless device that is physically closer to the cell edge is allocated an RB that is closer to an end of the RF spectrum band (and for which the MPR is therefore relatively large). As a result of the larger MPR, the wireless device may experience poor throughput or loss of coverage. This problem may be exacerbated by the deployment of newer multiple user-MIMO (MU-MIMO) features, which allow a single access point to transmit to multiple wireless devices simultaneously.

Additionally, when the physical uplink control channel (PUCCH) is allocated an RB that is closer to an end of the RF spectrum band (relative to an RB that is allocated to the physical uplink shared channel (PUSCH) which is transmitting at the same time as the PUCCH), both the uplink and downlink throughput may be negatively impacted. Moreover, the coverage of the cell may be reduced, because the PUCCH carries critical control messages.

5G networks also allow for partial bandwidth to be allocated to a wireless device that does not require the entire bandwidth of an allocated RB. The partial bandwidth that is allocated may be referred to as a “bandwidth part” (BWP). If the BWP that is allocated to a wireless device is from an RB that is located near an end of the RF spectrum band, then the wireless device may experience lower data rates, even if RBs that are closer to the middle of the spectrum band are not being utilized.

In addition, many different types of services (e.g., including enhanced mobile broadband (eMBB), ultra-reliable and low latency communications (URLLC), and massive machine-type communications (mMTC)) may compete for the limited RF resources in a 5G network. When a critical service, such as URLLC or a first responder service, is assigned an RB that is closer to an end of the spectrum band, the critical service may be unable to acquire the necessary quality of service (QOS) to support the critical service effectively.

Examples of the present disclosure allocate RBs of an RF spectrum band in an intelligent manner, accounting for application or service requirements, radio conditions, and/or channel types which may affect the impact of MPR on wireless devices. For instance, in one example, wireless devices that are closer to the edge of a cell (and therefore more likely to be negatively impacted by MPR) may be allocated RBs that are closer to the middle of the RF spectrum band. At the same time, wireless devices that are closer to the near cell (and therefore less likely to be negatively impacted by MPR) may be allocated RBs that are closer to an end of the RF spectrum band, because those wireless devices will tend to have greater power headroom. Similar priority may be given to PUCCH sharing resources with PUSCH, to wireless devices utilizing BWP, or to critical services with high QoS requirements. By allocating the RBs in the disclosed manner rather than randomly, uplink throughput in the RF spectrum band can be increased and MPR can be mitigated.

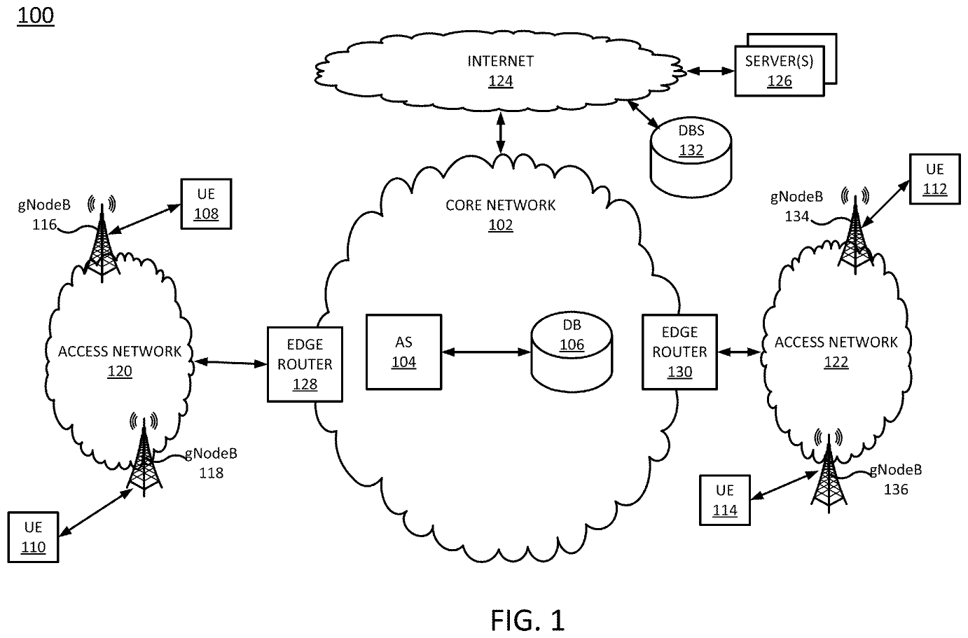

Within the context of the present disclosure, a resource block or RB is understood to refer to the smallest unit of resources within an RF spectrum band that can be allocated to a wireless device. In 5G networks, a transmission may comprise a plurality of radio frames, where each radio frame has a duration of ten milliseconds. Each frame may, in turn, be divided into ten subframes, and each subframe may be further divided into two slots. A physical resource block (PRB) is the smallest unit of a radio resource frame that comprises one slot and twelve consecutive subcarriers, where a subcarrier is the smallest unit of frequency domain. A resource block may encompass a single PRB, or multiple PRBs. In 5G, the bandwidth of an RB is variable depending upon subcarrier spacing. The maximum number of PRBs in a spectrum band is determined by the configuration of the channel bandwidth (BW) and subcarrier bandwidth. For instance, in a C-band with a 100 MHz bandwidth and a 30 MHz subcarrier, the maximum number of PRBs can be up to 273. These and other aspects of the present disclosure are discussed in greater detail in connection with FIGS. 1-4, below.

To further aid in understanding the present disclosure, FIG. 1 illustrates an example system 100 in which examples of the present disclosure for intelligently allocating resource blocks of a radio frequency spectrum band based on maximum power reduction may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), mobile cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

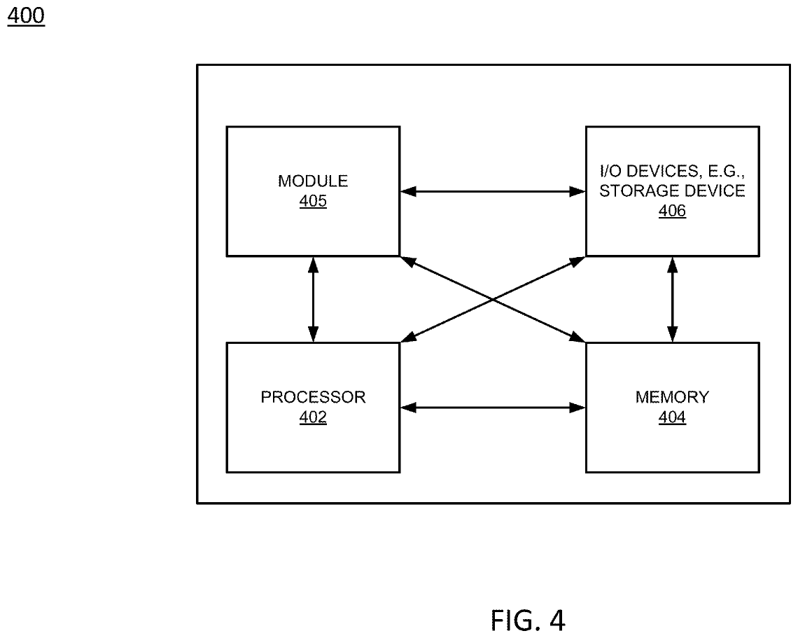

In one example, the access network 120 may be in communication with one or more user endpoint devices 108 and 110. The user endpoint devices 108 and 110 may connect to the access network 120 via one or more base stations (e.g., gNodeBs) 116 and 118. Similarly, the access network 122 may be in communication with one or more user endpoint devices 112 and 114. The user endpoint devices 112 and 114 may connect to the access network 120 via one or more base stations (e.g., gNodeBs) 134 and 136. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 400 depicted in FIG. 4, and may be configured as described below. For example, the user endpoint devices 108, 110, 112, and 114 may each comprise a smart phone, a tablet computer, a laptop computer, a gaming device, a wearable smart device (e.g., a smart watch, a head mounted display, or the like), an IoT device, a connected vehicle, a bank or cluster of such devices, and the like.

In one example, one or more servers 126 and one or more databases 132 may be accessible to user endpoint devices 108, 110, 112, and 114 via Internet 124 in general. The server(s) 126 and DBs 132 may be associated with Internet software applications that may exchange data with the user endpoint devices 108, 110, 112, and 114 over the Internet 124.

In accordance with the present disclosure, one or more of the base stations 116, 118, 134, or 136 may be configured to provide one or more operations or functions in connection with examples of the present disclosure for intelligently allocating resource blocks of a radio frequency spectrum band based on maximum power reduction, as described herein. For instance, in one example, each base station 116, 118, 134, or 136 may monitor a plurality of user endpoint devices (e.g., including user endpoint devices 108, 110, 112, and 114) that are physically present within a cell that is served by each base station 116, 118, 134, or 136. Each base station 116, 118, 134, or 146 may allocate resource blocks of an RF spectrum band of the cell among the plurality of user endpoint devices in an intelligent, non-arbitrary manner based on which of the plurality of user endpoints devices are most or least likely to be negatively impacted by MPR. As discussed above, MPR is often used to mitigate signal predistortion at the ends of an RF spectrum band, but can result in coverage loss (of up to a few miles) due to poor RSRP and poor SINR.

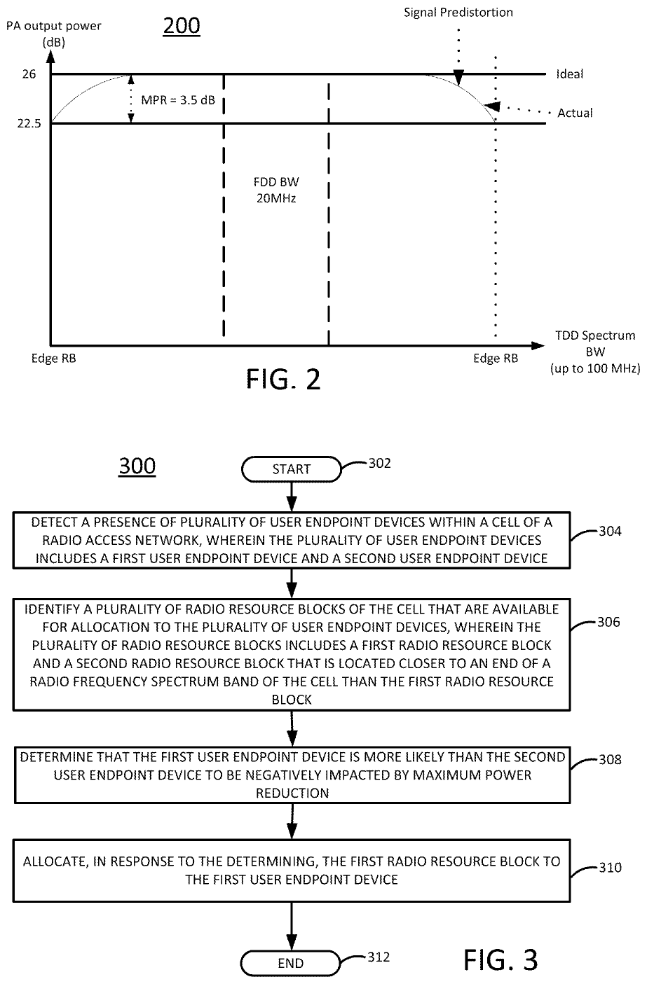

FIG. 2, for instance, illustrates a graph 200 plotting the output power of a power amplifier (PA) in dB against the bandwidth of a radio frequency spectrum band in MHz. As illustrated, the output power is mostly linear (holding at approximately 26 dB) over the width of the RF spectrum band, which may be as wide as nine hundred MHz. However, at the ends of edges of the RF spectrum band, MPR may lower the output power by as much as 3.5 dB (i.e., to 22.5 dB).

Table 1, below, illustrates some example uplink MPR values for power class 2, as provided by 3GPP 38.521-1:

TABLE 1
MPR (in dB) for Power Class 2

| | MPR | MPR | MPR |
|---|---|---|---|
| Modulation | of edge RBs | of outer RBs | of inner RBs |
| DFT-s-OFDM PI/2 BPSK | ≤3.5 | ≤0.5 | 0 |
| DFT-s-OFDM QPSK | ≤3.5 | ≤1 | 0 |
| DFT-s-OFDM 16 QAM | ≤3.5 | ≤2 | ≤1 |
| DFT-s-OFDM 64 QAM | ≤3.5 | ≤2.5 | ≤2.5 |
| DFT-s-OFDM 256 QAM | ≤4.5 | ≤4.5 | ≤4.5 |
| CP-OFDM QPSK | ≤3.5 | ≤3 | ≤1.5 |
| CP-OFDM 16 QAM | ≤3.5 | ≤3 | ≤2 |
| CP-OFDM 64 QAM | ≤3.5 | ≤3.5 | ≤3.5 |
| CP-OFDM 256 QAM | ≤6.5 | ≤6.5 | ≤6.5 |

The first five modulation types in Table 1 (i.e., DFT-s-OFDM PI/2 BPSK through DFT-s-OFDM 256 QAM) may be utilized near the cell edge, while the last four modulation types (i.e., CP-OFDM QPSK through CP-OFDM 256 QAM) may be utilized in the near cell. “Inner” RBs may be RBs closest to the middle of the RF spectrum band. “Edge” RBs may be RBs closest to the ends of the RF spectrum band. “Outer” RBs may be RBs that are located between the inner RBs and the edge RBs.

As shown in Table 1, for the same modulation type quadrature phase shift keying (QPSK) and waveform, MPR may be as low as zero for inner RB allocations and as high as 3.5 dB for edge RB allocations for power class 2.

Table 2, below, illustrates some example uplink MPR values for power class 1.5, as provided by 3GPP 38.521-1:

TABLE 2
MPR (in dB) for Power Class 1.5

| | MPR | MPR | MPR |
|---|---|---|---|
| Modulation | of edge RBs | of outer RBs | of inner RBs |
| DFT-s-OFDM PI/2 BPSK | 6 | 2 -> 1.5 | 0.5 -> 0 |
| DFT-s-OFDM QPSK | 6.5 | 2.5 -> 2 | 0.5 -> 0 |
| DFT-s-OFDM 16 QAM | 6.5 | 3.5 -> 3 | 1.5 -> 1 |
| DFT-s-OFDM 64 QAM | 6.5 | 4 -> 3.5 | 3.5 -> 3 |
| DFT-s-OFDM 256 QAM | 6.5 | 6.5 | 6.5 |
| CP-OFDM QPSK | 6.5 | 4.5 | 2 |
| CP-OFDM 16 QAM | 6.5 | 4.5 | 2.5 |
| CP-OFDM 64 QAM | 6.5 | 5 | 4.5 |
| CP-OFDM 256 QAM | 8.5 | 8.5 | 8.5 |

As shown in Table 2, for the same modulation type QPSK and wave form, MPR may be as low as zero for inner RB allocations (similar to power class 2). However, MPR may be as high as 6.5 dB for edge RB allocations for power class 1.5.

It can be seen from Table 1 and Table 2 that MPR may vary significantly for different RB allocations within the same RF spectrum band and for different modulation types. Depending upon the physical location of a user endpoint device 108, 110, 112, or 114 within a cell, upon whether a user endpoint device 108, 110, 112, or 114 is used to convey control messages or data related to critical services (e.g., URLLC or first responder services), or upon whether a user endpoint device 108, 110, 112, or 114 utilizes a BWP, certain user endpoint devices 108, 110, 112, or 114 may be less impacted by higher MPR than other user endpoint devices 108, 110, 112, or 114. According to examples of the present disclosure, a base station 116, 118, 134, or 136 may determine which user endpoint devices of a plurality of user endpoint devices within a cell are less likely to be negatively impacted by MPR and may allocate RBs that are closer to the ends of an RF spectrum band to those user endpoint devices. Similarly, the base station 116, 118, 134, or 136 may determine which user endpoint devices of the plurality of user endpoint devices within the cell are more likely to be negatively impacted by MPR and may allocate RBs that are closer to the middle of the RF spectrum band to those user endpoint devices.

For instance, in one example, where a plurality of user endpoint devices 108, 110, 112, and 114 are sharing the RF spectrum band, the user endpoint devices that are closer to the cell edge may experience poor throughput or loss of coverage if the user endpoint devices are allocated RBs that are closer to the ends of the RF spectrum band due to the relatively large MPR associated with these RBs. Thus, the user endpoint devices that are closer to the cell edge may be allocated RBs that are closer to the middle of the RF spectrum band. The RBs that are closer to the ends of the RF spectrum band may be reserved for the user endpoint devices that are closer to the near cell, which are more likely to have the power headroom to mitigate the effects of the relatively large MPR.

In another example, where the PUCCH and the PUSCH are sharing the RF spectrum band, the RBs that are closer to the middle of the RF spectrum band may be reserved for the PUCCH, which carries critical control messages that cannot afford to be delayed due to higher MPR. RBs that are closer to the ends of the RF spectrum band may be allocated to the PUSCH.

In another example, where some user endpoint devices may be utilizing services that operate under a relatively low data rate that does not require the entire bandwidth of an RB (e.g., the user endpoint devices are using BWPs), and RBs that are closer to the middle of the RF spectrum band are available, the RBs closer to the middle of the RF spectrum band may be allocated to the user endpoint devices before allocating the RBs closer to the ends of the RF spectrum band. This will ensure that the data rate experienced by the user endpoint devices is not inadvertently reduced further due to MPR.

In another example, where a plurality of services (e.g., eMBB, URLLC, mMTC, first responder services, etc.) are competing, via a plurality of user endpoint devices, for the same RF spectrum band, the RBs that are located closer to the middle of the RF spectrum band may be reserved for those services that are determined to be more critical and therefore require more reliable QoS, such as URLLC and first responder services. Those services that are determined to be less critical may be allocated the RBs that are located closer to the ends of the RF spectrum band.

In one example, at least one of the DBs 106 or 132 may contain profiles associated with user endpoint devices and/or services which help a base station 116, 118, 134, or 136 to prioritize which user endpoint devices in a cell should be allocated the RBs that are the closest to the middle of an RF spectrum band. For instance, the profiles may contain information that helps a base station 116, 118, 134, or 136 to detect when traffic to or from a user endpoint device is associated with the PUCCH or with a critical service, or uses a BWP. The profiles may also be continuously updated with location data for user endpoint devices that may move within a cell or even move between two or more different cells. In one example, the DB 106 may comprise a physical storage device integrated with the AS 104 (e.g., a database server or a file server), or attached or coupled to the AS 104, in accordance with the present disclosure.

The base stations 116, 118, 134, and 136 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the base stations 116, 118, 134, and 136 may load instructions into a memory, or one or more distributed memory units, and execute the instructions for intelligently allocating resource blocks of a radio frequency spectrum band based on maximum power reduction, as described herein. For instance, an example method for intelligently allocating resource blocks of a radio frequency spectrum band based on maximum power reduction is discussed in further detail below in connection with FIG. 3.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 3 illustrates a flowchart of an example method 300 for intelligently allocating resource blocks of a radio frequency spectrum band based on maximum power reduction, in accordance with the present disclosure. In one example, the method 300 may be performed by a base station of a radio access network, such as any of the base stations 116, 118, 134, or 136 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may detect a presence of a plurality of user endpoint devices within a cell of a radio access network, wherein the plurality of user endpoint devices includes a first user endpoint device and a second user endpoint device.

In one example, the RAN may be a 5G cellular network, and the cell of the 5G cellular network may be served by a base station (e.g., a gNodeB) of which the processing system is a part. The plurality of user endpoint devices may include at least one of: a smart phone, a tablet computer, a laptop computer, a gaming device, a wearable smart device (e.g., a smart watch, a head mounted display, or the like), an IoT device, a connected vehicle, a bank or cluster of such devices, or the like.

In step 306, the processing system may identify a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block. In one example, the plurality of user endpoint devices may share the RF spectrum band of the cell. In one example, the RF spectrum band may comprise an n77 band, an n78 band, an n79 band, or the like, and may have a bandwidth of up to 900 MHZ. The plurality of RBs may be defined over the width of the RF spectrum band. For instance, some RBs of the plurality of RBs, like the first RB, may be located closer to a middle of the RF spectrum band. Conversely, some RBs of the plurality of RBs, like the second RB, may be located closer to the ends of the RF spectrum band.

In one example, the closer an RB is located to an end of the RF spectrum band, the higher the MPR associated with the RB is. Conversely, the closer an RB is located to the middle of the RF spectrum band, the lower the MPR associated with the RB is. For instance, some RBs located closer to the middle of the RF spectrum band may be associated with MPR as low as zero dB. In one example, the MPR associated with the RBs at the furthest ends of the RF spectrum band may be as high as 3.5 dB.

In step 308, the processing system may determine that the first user endpoint device is more likely than the second user endpoint device to be negatively impacted by maximum power reduction. In one example, there are a plurality of reasons why the first user endpoint device may be more likely than the second user endpoint device to be negatively impacted by MPR.

For instance, in one example, the first user endpoint device may be located closer to the cell edge that the second user endpoint device. As a result, the coverage and/or throughput experienced by the first user endpoint device may not be as good as the coverage and/or throughput experienced by the second user endpoint device. In this case, allocating an RB that is closer to an end of the RF spectrum band (and therefore associated with a larger MPR), such as the second RB, may cause a further degradation of the coverage and/or throughput experienced by the first user endpoint device. Allocating an RB that is closer to the middle of the RF spectrum band (and therefore associated with a smaller MPR) may mitigate any degradation in coverage and/or throughput that the first user endpoint device may experience as a result of its proximity to the cell edge. Similarly, the second user endpoint device, which is closer to the near cell, may experience less degradation in coverage and/or throughput even when larger MPR is applied; thus, allocating an RB that is closer to the end of the RF spectrum band to the second user endpoint device may not have a significant negative impact on the second user endpoint device.

In another example, the first user endpoint device may be utilized by the PUCCH, which may transmit at the same time as the PUSCH. In this case, a degradation in coverage as a result of applying a higher MPR may delay the delivery of critical control messages. Thus, allocating an RB that is closer to the middle of the RF spectrum band (and associated with a smaller MPR) to the first user endpoint device may ensure that the PUCCH has the necessary coverage to deliver the critical control messages. RBs that are closer to the ends of the RF spectrum band (and associated with higher MPR) may be reserved for the PUSCH and user endpoint devices utilized by the PUSCH.

In another example, the first user endpoint device may utilize a BWP, while the second user endpoint device may not utilize a BWP. In this case, if the BWP allocated to the first user endpoint device comprises an RB that is closer to an end of the RF spectrum band, then the already reduced data rate experienced by the first user endpoint device may be inadvertently further reduced due to the higher MPR. By allocating an RB that is closer to the middle of the RF spectrum band, when available, to the first user endpoint device, the first user endpoint device may be more likely to experience the data rate that is not unnecessarily low. Thus, when the first user endpoint device is utilizing a BWP and an RB that is closer to the middle of the RF spectrum band is available, the RB that is closer to the middle of the RF spectrum band may be allocated to the first user endpoint device before considering RBs located further away from the middle of the RF spectrum band.

In another example, the first user endpoint device may be in use by a service that requires differentiated handling and/or access to priority handling. For instance, the first user endpoint device may be in use by URLLC or a first responder service, while the second user endpoint device may be in use by a service that is considered less critical that URLLC or the first responder service (e.g., eMBB, mMTC, or the like). RBs that are located closer to the ends of the RF spectrum band (and associated with higher MPR) may be incapable of providing the QoS that is required for the priority service using the first user endpoint device (where the QoS may be defined by a service level agreement or similar agreement). Thus, the first user endpoint device may be given priority access to RBs located closer to the middle of the RF spectrum band when the first user endpoint device is in use by a critical service such as URLLC or a first responder service.

In step 310, the processing system may allocate, in response to the determining, the first resource block to the first user endpoint device. In one example, the processing system may further allocate, in response to the determining, the second resource block to the second user endpoint device. The method 300 may end in step 312.

Although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure allocate RBs of an RF spectrum band in an intelligent manner, accounting for application or service requirements, radio conditions, and/or channel types which may affect the impact of MPR on wireless devices. For instance, in once example, wireless devices that are closer to the edge of a cell (and therefore more likely to be negatively impacted by MPR) may be allocated RBs that are closer to the middle of the RF spectrum band. At the same time, wireless devices that are closer to the near cell (and therefore less likely to be negatively impacted by MPR) may be allocated RBs that are closer to an end of the RF spectrum band, because those wireless devices will tend to have greater power headroom. Similar priority may be given to PUCCH sharing resources with PUSCH, to wireless devices utilizing BWP, or to critical services with high QoS requirements. By allocating the RBs in the disclosed manner rather than randomly, uplink throughput in the RF spectrum band can be increased and MPR can be mitigated.

FIG. 4 depicts a high-level block diagram of a computing device specifically programmed to perform the functions described herein. For example, any one or more components or devices illustrated in FIG. 1 or described in connection with the method 300 may be implemented as the system 400. For instance, a RAN network base station (such as might be used to perform the method 300) could be implemented as illustrated in FIG. 4.

As depicted in FIG. 4, the system 400 comprises a hardware processor element 402, a memory 404, a module 405 for intelligently allocating resource blocks of a radio frequency spectrum band based on maximum power reduction, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for intelligently allocating resource blocks of a radio frequency spectrum band based on maximum power reduction may include circuitry and/or logic for selecting resource blocks of a radio frequency spectrum for allocation to user endpoint devices. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for intelligently allocating resource blocks of a radio frequency spectrum band based on maximum power reduction (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for intelligently allocating resource blocks of a radio frequency spectrum band based on maximum power reduction (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, a presence of a plurality of user endpoint devices within a cell of a radio access network, wherein the plurality of user endpoint devices includes a first user endpoint device and a second user endpoint device;
identifying, by the processing system, a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block;
determining, by the processing system, that the first user endpoint device is more likely than the second user endpoint device to be negatively impacted by maximum power reduction; and
allocating, by the processing system in response to the determining, the first resource block to the first user endpoint device.

2. The method of claim 1, wherein the radio access network is a fifth generation radio access network.

3. The method of claim 2, wherein the fifth generation radio access network supports a time division duplexing mode.

4. The method of claim 3, wherein the radio frequency spectrum band has a bandwidth of up to nine hundred megahertz.

5. The method of claim 4, wherein the radio frequency spectrum band is at least one of: an n77 band, an n78 band, or an n79 band.

6. The method of claim 1, wherein a magnitude of the maximum power reduction is greater for the second resource block than for the first resource block.

7. The method of claim 6, wherein the magnitude of the maximum power reduction ranges from approximately zero decibels to approximately 3.5 decibels moving from a middle of the radio frequency spectrum band to the end of the radio frequency spectrum band.

8. The method of claim 6, wherein the magnitude of the maximum power reduction ranges from approximately zero decibels to approximately 6.5 decibels moving from a middle of the radio frequency spectrum band to the end of the radio frequency spectrum band.

9. The method of claim 6, wherein the determining comprises determining that the first user endpoint device is located closer to an edge of the cell than the second user endpoint device.

10. The method of claim 6, wherein the determining comprises determining that the first user endpoint device is utilizing ultra-reliable and low latency communications.

11. The method of claim 6, wherein the determining comprises determining that the first user endpoint device is utilizing a first responder service.

12. The method of claim 6, wherein the determining comprises determining that the first user endpoint device is supporting a physical uplink control channel.

13. The method of claim 6, wherein the determining comprises determining that the first user endpoint device is utilizing a bandwidth part.

14. The method of claim 1, wherein the allocating further comprises allocating the second resource block to the second user endpoint device.

15. The method of claim 1, wherein the processing system is part of a base station that provides radio frequency coverage to the cell.

16. A non-transitory computer-readable medium storing instructions which, when executed by a processing system including at least one processor, cause the processing system to perform operations, the operations comprising:
detecting a presence of a plurality of user endpoint devices within a cell of a radio access network, wherein the plurality of user endpoint devices includes a first user endpoint device and a second user endpoint device;
identifying a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block;
determining that the first user endpoint device is more likely than the second user endpoint device to be negatively impacted by maximum power reduction; and
allocating, in response to the determining, the first resource block to the first user endpoint device.

17. The non-transitory computer-readable medium of claim 16, wherein a magnitude of the maximum power reduction is greater for the second resource block than for the first resource block.

18. The non-transitory computer-readable medium of claim 17, wherein the determining comprises determining that the first user endpoint device is located closer to an edge of the cell than the second user endpoint device.

19. The non-transitory computer-readable medium of claim 17, wherein the determining comprises determining that the first user endpoint device is utilizing a first responder service.

20. A device comprising:
a processing system including at least one processor; and
a computer-readable medium storing instructions which, when executed by the processing system, cause the processing system to perform operations, the operations comprising:
detecting a presence of a plurality of user endpoint devices within a cell of a radio access network, wherein the plurality of user endpoint devices includes a first user endpoint device and a second user endpoint device;
identifying a plurality of resource blocks of the cell that are available for allocation to the plurality of user endpoint devices, wherein the plurality of resource blocks includes a first resource block and a second resource block that is located closer to an end of a radio frequency spectrum band of the cell than the first resource block;
determining that the first user endpoint device is more likely than the second user endpoint device to be negatively impacted by maximum power reduction; and
allocating, in response to the determining, the first resource block to the first user endpoint device.
